(19) United States
(12) Patent Application Publication
(10) Pub. No.: US 2015/0025694 A1
(43) Pub. Date: Jan. 22, 2015

(54) CONTROL APPARATUS HAVING A MICROPROCESSOR CONTROLLER FOR ENERGY CONSERVATION AND FUEL ECONOMY

(71) Applicant: Kuo Chi Chang, Kaohsiung City (TW)

(72) Inventor: Kuo Chi Chang, Kaohsiung City (TW)

(21) Appl. No.: 13/944,085

(22) Filed: Jul. 17, 2013

(51) Int. Cl. G05D 7/06; F02D 41/00

(52) U.S. Cl. CPC G05D 7/0617; F02D 41/0025
USPC 700/282

(57) ABSTRACT

A control apparatus having a microprocessor controller for energy conservation and fuel economy includes a liquid container containing a combustion supporting agent; a metering pump having a liquid inlet and a liquid outlet. The liquid inlet communicates with the liquid container; a vaporizer communicating with the liquid outlet of the metering pump; and a microprocessor controller electrically connected to the metering pump. The microprocessor controller controls the flow rate at which the combustion supporting agent is pumped out of the liquid container by the metering pump and the flow rate at which the combustion supporting agent is discharged into the vaporizer by the metering pump. The vaporizer atomizes the combustion supporting agent. The flow rate of the combustion supporting agent is controlled for combustion efficiency.

### BACKGROUND OF THE INVENTION

1. Technical Field

The present invention relates to a control apparatus, and more specifically, to a control apparatus having a microprocessor controller for energy conservation and fuel economy, wherein the microprocessor controller is configured to optimize the output flow rate of a combustion supporting agent so as to improve the combustion efficiency of the combustion chamber of combustion equipment.

2. Description of Related Art

Automobiles are a means of transportation that consumes fuel, typically a refined product of petroleum. After fuel enters the combustion chamber of an automobile engine, in the form of a fully atomized mixture with air, power is generated through combustion initiated by ignition or compression. However, carbon resulting from incomplete combustion of fuel is prone to build up on the inner wall of the engine cylinder and may lead to emission of hydrocarbon particles. As is well known, an excessive amount of such hydrocarbon particles can cause environmental pollution, in addition to affecting energy output performance of an engine and making the engine severely worn. Nowadays, one common solution to the engine performance problem is to add a combustion supporting agent or a carbon removing agent.

Besides, far infrared (FIR) fuel economizers are commercially available to enhance combustion efficiency. FIR fuel economizers can be generally divided into the following two types based on their use modes. An FIR fuel economizer of the first type is mounted on a liquid inlet tube, and the FIR radiation emitted from the fuel economizer can penetrate the liquid inlet tube to miniaturize liquid fuel molecules, thereby enabling complete combustion of fuel and avoiding carbon buildup. An FIR fuel economizer of the other type is placed inside a liquid fuel container and can directly act on the fuel in the liquid fuel container in order to raise the activity of fuel molecules.

Taiwan Utility Model Patent No. M323522 discloses a fuel economizer structure for automobile engines, wherein the main body of the fuel economizer comprises an air inlet, an air outlet, a liquid container, a liquid flow regulating valve, and a liquid inlet. External air is driven into the main body of the fuel economizer through vacuum attraction and is mixed with the combustion supporting agent in the main body of the fuel economizer The mixture is then subjected to high pressure and turns into an atomized liquid. The atomized liquid is led to a vacuum tube and a throttle and is compressed again to form a gas, allowing the combustion supporting agent to mix with gasoline rapidly. Thus, once gasoline is injected into the engine cylinder and ignited, complete combustion takes place, which increases power output and minimizes the use of gasoline.

The foregoing structure, though capable of improving combustion efficiency, fails to adjust the amount of combustion supporting agent according to practical situations and therefore may not utilize the combustion supporting agent efficiently.

Considering the problems in the prior arts, the inventor of the present invention incorporated years of experience in the field with continual improvements and successfully developed the present invention.

### BRIEF SUMMARY OF THE INVENTION

The present invention provides a control apparatus having a microprocessor controller for energy conservation and fuel economy, wherein the control apparatus controls the flow rate of a combustion supporting agent either with the microprocessor controller or depending on practical situations so as to improve the combustion efficiency of a combustion chamber, thereby preventing wasteful use of the combustion supporting agent.

One objective of the present invention is to provide a control apparatus having a microprocessor controller for energy conservation and fuel economy in order to solve the foregoing problems. The control apparatus comprises: a liquid container filled with a combustion supporting agent; a metering pump having a liquid inlet and a liquid outlet, wherein the liquid inlet communicates with the liquid container so that the combustion supporting agent can flow into the metering pump via the liquid inlet; a vaporizer communicating with the liquid outlet of the metering pump and with a combustion chamber; and a microprocessor controller electrically connected to the metering pump, wherein the microprocessor controller controls the flow rate at which the combustion supporting agent is pumped out of the liquid container by the metering pump and the flow rate at which the combustion supporting agent is discharged into the vaporizer by the metering pump, and wherein the vaporizer atomizes the combustion supporting agent.

Preferably, the metering pump is provided with a stepping motor. The stepping motor is electrically connected to the microprocessor controller, and the two ends of the stepping motor are in communication with the liquid inlet and the liquid outlet respectively. The microprocessor controller controls the flow rate at which the combustion supporting agent is pumped out of the liquid container by the stepping motor and the flow rate at which the combustion supporting agent is discharged into the vaporizer by the stepping motor.

Preferably, the minimum flow rate at which the combustion supporting agent is discharged into the vaporizer by the metering pump under the control of the microprocessor controller is 0.1 c.c./hr.

Preferably, the microprocessor controller is electrically connected to a sensor. The sensor is used to detect changes caused by combustion, convert the changes into an electric signal, and send the electric signal to the microprocessor controller, so as for the microprocessor controller to compute an electric signal for achieving optimal energy conservation and thereby control the metering pump to deliver the combustion supporting agent at an optimal flow rate.

Preferably, the microprocessor controller is electrically connected to an engine speed sensor, a pressure sensor, an oxygen sensor, or a temperature sensor in order to detect changes in engine performance and to send a corresponding electric signal to the microprocessor controller. The microprocessor controller performs computation according to the electric signal sent from the sensor so as to control the stepping motor to deliver the combustion supporting agent at an optimal flow rate.

The above and other objectives of the present invention and advantages thereof can be further understood by referring to the following detailed description of selected embodiments and the accompanying drawings.

It should be noted that, while the structures of the components of the present invention are demonstrated in detail in the present specification and the accompanying drawings by way of the selected embodiments, some of the components and their arrangements may vary in practice.

### BRIEF DESCRIPTION OF THE SEVERAL VIEWS OF THE DRAWINGS

The technical means disclosed in the present invention and the advantages of the present invention will be best understood and acknowledged by referring to the following detailed description of some illustrative embodiments in conjunction with the accompanying drawings, in which:

FIG. 1 is a perspective view of the control apparatus having a microprocessor controller for energy conservation and fuel economy of the present invention; and

FIG. 2 is a side view of the control apparatus having a microprocessor controller for energy conservation and fuel economy of the present invention.

### DETAILED DESCRIPTION OF THE INVENTION

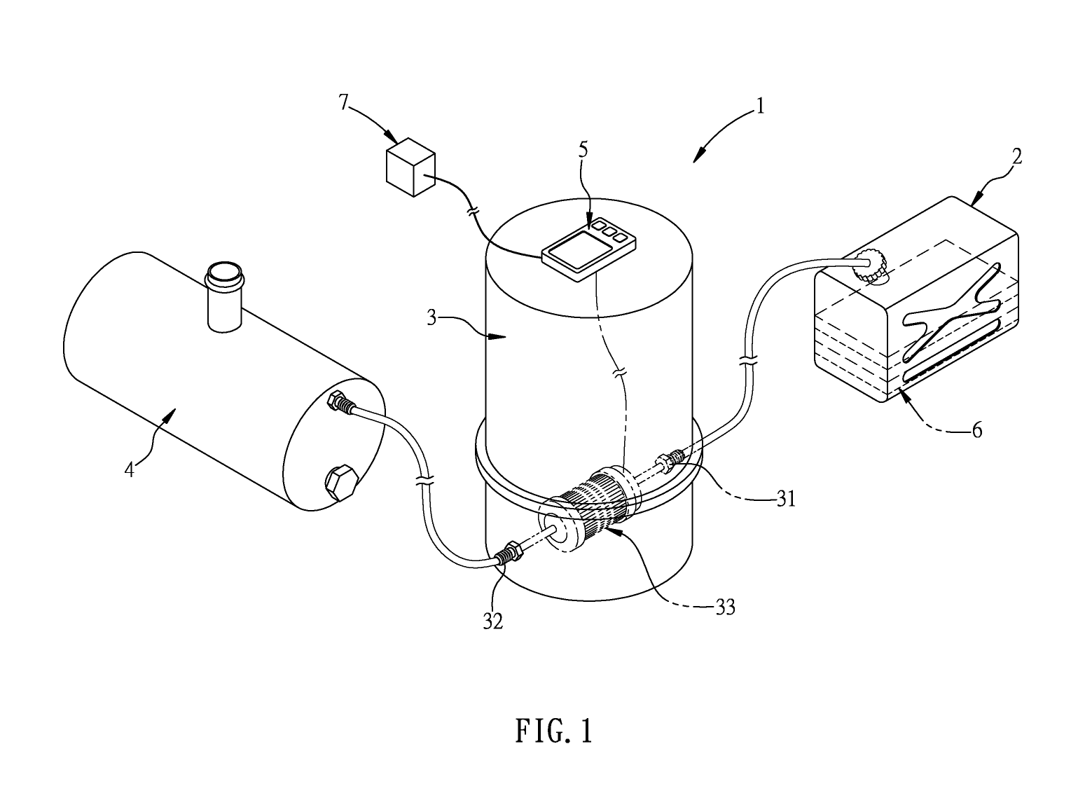

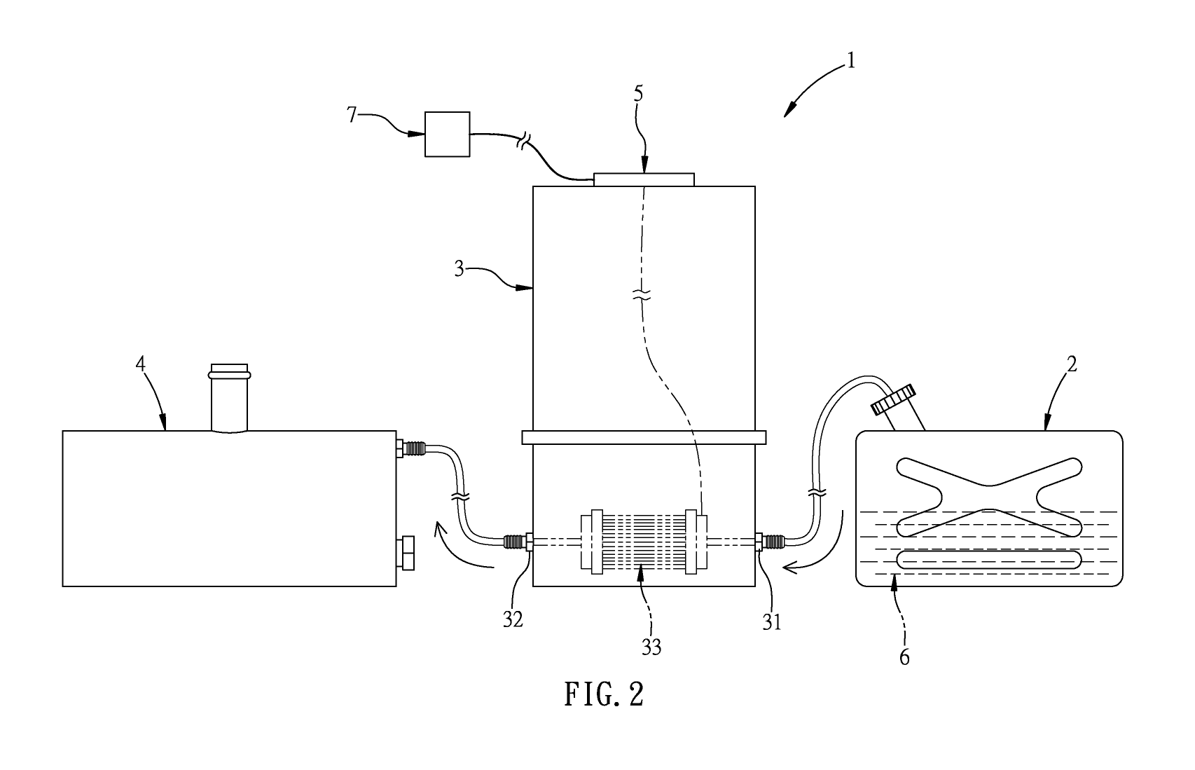

Please refer to FIG. 1-2 for an embodiment of the present invention, in which a control apparatus 1 having a microprocessor controller for energy conservation and fuel economy comprises a liquid container 2, a metering pump 3, a vaporizer 4, and a microprocessor controller 5. The control apparatus 1 of the present invention is applicable to various types of combustion equipment, such as the combustion equipment of boilers, automobiles, motorcycles, electric generators, watercrafts, and aircrafts, as well as equipment designed for open combustion. The control apparatus 1 is so designed that a small amount of atomized (or vaporized) material is fed into the intended combustion equipment as a result of a gas pressure difference and is mixed with a fuel to facilitate combustion and conserve energy.

Moreover, the control apparatus 1 of the present invention is further applicable to various flammable fuels, such as gasoline, diesel, heavy crude oil, coal, coal gas (or gas), and wood.

The liquid container 2 is filled with a combustion supporting agent 6.

The metering pump 3 comprises a liquid inlet 31 and a liquid outlet 32, wherein the liquid inlet 31 communicates with the liquid container 2, and the combustion supporting agent 6 flows into the metering pump 3 via the liquid inlet 31.

The vaporizer 4 is in communication with the liquid outlet 32 of the metering pump 3 and is also in communication with a combustion chamber (not shown in the drawings). The vaporizer 4 is used to atomize the combustion supporting agent 6 and pass the atomized combustion supporting agent 6 to the combustion chamber (not shown in the drawings) so as to increase combustion efficiency by at least 30%. The vaporizer 4 and the metering pump 3 are separately provided such that the vaporizer 4, when installed in an automobile or a boiler, takes up only a limited amount of space, allowing great flexibility in the use of space.

The microprocessor controller 5 is electrically connected to the metering pump 3. Moreover, the metering pump 3 can further comprise a stepping motor 33 therein, wherein the stepping motor 33 is electrically connected to the microprocessor controller 5.

The two ends of the stepping motor 33 are in communication with the liquid inlet 31 and the liquid outlet 32 of the metering pump 3 respectively. The microprocessor controller 5 can be configured to control the flow rate at which the stepping motor 33 pumps the combustion supporting agent 6 out of the liquid container 2 and the flow rate at which the stepping moor 33 discharges the combustion supporting agent 6 into the vaporizer 4.

Moreover, the microprocessor controller 5 can be further electrically connected to a sensor 7. The sensor 7 is used to detect changes caused by combustion and convert the changes into an electric signal. The electric signal is sent to the microprocessor controller 5 in order for the microprocessor controller 5 to compute an electric signal for achieving optimal energy conservation, and with the latter electric signal, the microprocessor controller 5 controls the stepping motor 33 to deliver the combustion supporting agent 6 at an optimal flow rate. For example, if the present invention is applied to an automobile, the sensor 7 can, depending on the type of the automobile, be one selected from an engine speed sensor, a pressure sensor, an oxygen sensor, and a temperature sensor, in order to detect changes in engine performance and pass the electric signal to the microprocessor controller 5. After receiving the electric signal sent from the sensor 7, the microprocessor controller 5 computes, according to the electric signal, the flow rate at which the combustion supporting agent 6 should be pumped out of the liquid container 2 by the stepping motor 33 and the flow rate at which the combustion supporting agent 6 should be discharged into the vaporizer 4 by the stepping motor 33.

Preferably, the minimum flow rate at which the combustion supporting agent 6 is discharged into the vaporizer 4 by the metering pump 3 (the stepping motor 33) under the control of the microprocessor controller 5 is 0.1 c.c/hr.

The embodiments described above serve to demonstrate the features of the present invention, and it is understood that the embodiments are not intended to limit the scope of the present invention. Any changes in value or replacement of equivalent components should be considered within the scope of the present invention.

What is claimed is:

1. A control apparatus having a microprocessor controller for energy conservation and fuel economy, comprising:
a liquid container filled with a combustion supporting agent;
a metering pump having a liquid inlet and a liquid outlet, wherein the liquid inlet is in communication with the liquid container, and the combustion supporting agent flows into the metering pump via the liquid inlet;
a vaporizer communicating with the metering pump via the liquid outlet and communicating with a combustion chamber; and
a microprocessor controller electrically connected to the metering pump, wherein the microprocessor controller controls a flow rate at which the combustion supporting agent is pumped out of the liquid container by the metering pump and a flow rate at which the combustion supporting agent is discharged into the vaporizer by the metering pump, and the vaporizer atomizes the combustion supporting agent.

2. The control apparatus of claim 1, wherein the metering pump is provided with a stepping motor, to which the microprocessor controller is electrically connected, and two ends of which are respectively in communication with the liquid inlet and the liquid outlet, and the microprocessor controller controls a flow rate at which the combustion supporting agent is pumped out of the liquid container by the stepping motor and a flow rate at which the combustion supporting agent is discharged into the vaporizer by the stepping motor.

3. The control apparatus of claim 1, wherein a minimum flow rate at which the combustion supporting agent is discharged into the vaporizer by the metering pump under control of the microprocessor controller is 0.1 c.c./hr.

4. The control apparatus of claim 1, wherein the microprocessor controller is electrically connected to a sensor, and the sensor detects changes in engine performance so as to send an electric signal to the microprocessor controller such that the microprocessor controller makes computation according to the electric signal sent from the sensor and thereby controls the metering pump to deliver the combustion supporting agent at an optimal flow rate.

5. The control apparatus of claim 2, wherein the microprocessor controller is electrically connected to a sensor, and the sensor detects changes in engine performance so as to send an electric signal to the microprocessor controller such that the microprocessor controller makes computation according to the electric signal sent from the sensor and thereby controls the stepping motor to deliver the combustion supporting agent at an optimal flow rate.

6. The control apparatus of claim 2, wherein a minimum flow rate at which the combustion supporting agent is discharged into the vaporizer by the metering pump under control of the microprocessor controller is 0.1 c.c./hr.

7. The control apparatus of claim 4, wherein the sensor is one of an engine speed sensor, a pressure sensor, an oxygen sensor, and a temperature sensor.

8. The control apparatus of claim 5, wherein the sensor is one of an engine speed sensor, a pressure sensor, an oxygen sensor, and a temperature sensor.
